(19) United States
(12) Patent Application Publication
(10) Pub. No.: US 2025/0377525 A1
(43) Pub. Date: Dec. 11, 2025

(54) METHOD FOR DETERMINING THE POSITION OF AT LEAST ONE PHASE OBJECT IN AN OBSERVATION REGION, AND OPTICAL OBSERVATION APPARATUS

(71) Applicant: Carl Zeiss Meditec AG, Jena (DE)

(72) Inventors: Markus SEESSELBERG, Aalen (DE); Christian BEDER, Aalen (DE); Holger MATZ, Unterschneidheim (DE)

(21) Appl. No.: 19/230,314

(22) Filed: Jun. 6, 2025

(30) Foreign Application Priority Data
Jun. 11, 2024 (DE) 10 2024 116 335.6

(51) Int. Cl. G02B 21/00; G02B 21/22; G02B 21/36

(52) U.S. Cl. CPC G02B 21/0056; G02B 21/0012; G02B 21/22; G02B 21/367

(57) ABSTRACT

Disclosed is a method and apparatus for ascertaining the position of a phase object in an imaged observation region, at least along the optical axis of an imaging beam path for imaging the observation region. The method includes recording digital images of the observation region by at least one image sensor, wherein the images each image a plane in the observation region that is conjugate to the image plane of the at least one image sensor. The method further includes varying the position of the conjugate plane in the observation region along the optical axis. The method further includes recording a stack of digital images of the observation region with different positions of the conjugate plane in the observation region. The method further includes ascertaining the position of the phase object along the optical axis from the stack of digital images by a digital image evaluation.

The present invention relates to a method for determining the position of at least one phase object in an observation region. The invention also relates to an optical observation apparatus, in particular a surgical microscope, configured to perform the method for determining the position of at least one phase object in an observation region.

In microscopy, phase objects are transparent objects that do not or only minimally change the amplitude, i.e. the intensity, of the light passing therethrough. Since phase objects are transparent, they are represented with little contrast in the image in a best-case scenario and are therefore difficult to observe. However, phase objects have a different refractive index to the surrounding medium, and so the optical path length of a light beam passing through the transparent object is modified vis-à-vis a light beam passing through the surrounding medium. This creates a phase difference between the light beam that passed through the transparent object and the light beam that passed through the surrounding medium. It is for this reason that transparent objects are also referred to as phase objects. What are known as phase contrast methods are used in microscopy to render phase objects better visible in the image. In this context, microscopes with phase contrast methods comprise equipment for illuminating the object with phase objects, which is adapted to the microscope objective used. However, such illumination equipment cannot be used in the field of ophthalmic surgery.

Phase objects that are observed with an optical observation apparatus are found in ophthalmic surgery. Examples in this respect are fragments of the crystalline lens, the capsular bag tear edge when the lens capsule is opened within the scope of capsulorhexis and transparent phaco tips of phaco needles. In this context, phaco needles denote medical instruments for comminuting and aspirating the crystalline lens. For instance, during cataract operations, in which the natural crystalline lens is removed and replaced with an artificial intraocular lens, the natural crystalline lens is comminuted by means of a phaco needle within the scope of what is known as phacoemulsification, and the lens fragments arising in the process are aspirated. In the process, it is important that all fragments of the crystalline lens are removed as completely as possible from the anterior chamber of the patient's eye in order to avoid medical complications such as an after-cataract. Phacoemulsification is performed by the physician while they observe the anterior chamber of the eye using a surgical microscope. In the process, the fundus is illuminated coaxially with the stereoscopic observation beam paths of the surgical microscope (so-called coaxial illumination). Illumination light reflected off and scattered by the fundus represents a secondary light source whose light serves to illuminate the lens fragments in the anterior chamber of the eye from behind. The transparent lens fragments are phase objects and therefore represented with little contrast in the image, and so a physician has difficulties in recognizing the lens fragments.

Since it is difficult to recognize phase objects in the image of a surgical microscope, the treating physician finds it difficult to move the instrument tip of an instrument for comminuting the crystalline lens into the vicinity of a lens fragment. However, it was possible to show that phase objects can be highlighted if they are situated at a small distance from a plane that is conjugate to the image sensor. This is based on the defocus-induced phase contrast method, which is known from conventional microscopy and presented in the following publication: U. Agero et al., “Defocusing microscopy”, Microscopy Research and Technique 65 (2004) pp. 159-165.On the basis of this discovery, US 2015/002814 A1 proposes a microscope system that is designed to displace the plane in the observation region that is conjugate to the image plane of an image sensor over a certain range along an optical axis and record images of the observation region for different positions of the conjugate plane. Then, in order to represent phase objects, a search is performed for an image sensor plane with a high contrast of the phase objects.

In this way, lens fragments can be represented with a contrast, for example within the scope of a cataract operation, and this facilitates the comminuting and removal of the lens fragments for the treating physician.

For example, within the scope of comminuting and removing lens fragments or when gripping the tear edge of the capsular bag of the crystalline lens with micro-tweezers, it might be helpful for a treating physician to know the position of the lens fragments or the tear edge along the optical axis. The problem addressed by the present invention therefore is that of providing a method and equipment with which the position of a phase object can be ascertained in an imaged observation region, at least along the optical axis of an imaging beam path for imaging the observation region.

According to the invention, this problem is solved by a method for ascertaining the position of a phase object in an imaged observation region as claimed in claim 1, by an optical observation apparatus as claimed in claim 11 and by a computer-implemented method for determining the position of a phase object in an observation region as claimed in claim 21. The dependent claims contain advantageous configurations of the invention.

According to the invention, a method is provided for ascertaining the position of a phase object, i.e. an object that does not change or only minimally changes the amplitude of the light passing therethrough, in an imaged observation region, at least along the optical axis of an imaging beam path for imaging the observation region. The method comprises the steps of:
recording digital images of the observation region by means of at least one image sensor, wherein the images each image a plane in the observation region that is conjugate to the image plane of the at least one image sensor. In this context, two planes are referred to as conjugate planes if a divergent beam emanating from a point in one of the planes is focused onto a point in the other plane by the optical imaging system. In this case, focusing onto a point only occurs in an idealized optical imaging system. In reality, aberrations of optical imaging systems lead to a divergent beam emanating from a point in a plane only being approximately refocused onto a point. Thus, to the extent that the present description refers to focusing onto a point, this should be interpreted to mean that the focusing onto a point is implemented within the scope of what is possible given the aberrations of the respective optical imaging system.
varying the position of the conjugate plane in the observation region along the optical axis, and recording a stack of digital images of the observation region with different positions of the conjugate plane in the observation region. In this case, a stack of digital images is considered to be a plurality of digital images that in each case image planes in the observation region that differ from one another in terms of their position along the optical axis. In this case, varying the position of the conjugate plane in the observation region along the optical axis can be realized in particular by displacing the at least one digital image sensor along the optical axis or by introducing, by means of an optical element, a defocus into the imaging beam path leading to the at least one image sensor.
ascertaining the position of the phase object along the optical axis from the stack of digital images by means of a digital image evaluation. In this case, the position of the phase object may be ascertained from the stack of digital images along the optical axis by ascertaining the contrasts of the phase object in the images from the stack of digital images in particular. For the digital image from the stack of digital images in which the phase object has the smallest contrast, the position of the conjugate plane in the observation region is ascertained along the optical axis, and the position of this conjugate plane in the observation region is assigned to the phase object as the position of the latter along the optical axis.

When phase objects are present in an observation region, the method according to the invention provides assistance for a treating physician in a number of ways. For example, it is possible to create a distribution of the phase objects along the optical axis should the positions of a number of phase objects be ascertained along the optical axis of the imaging beam path by means of the method according to the invention. As a result, it is possible to ascertain the spatial extent along the optical axis of the region containing the phase objects. Moreover, knowledge of the position of a phase object along the optical axis makes it possible to relate this position to other known positions in the observation region. For example, knowledge of the position of a phase object along the optical axis for example makes it possible to provide a physician with an indication as to whether they need to move a medical instrument upward or downward in order to bring said instrument into the same plane as said phase object. For as long as only amplitude objects are observed by means of an imaging beam path, a viewer recognizes that two objects are located in the same object plane by virtue of both objects being represented in focus at the same time. Should only phase objects be observed by means of an imaging beam path, an observer recognizes that two objects that are similar to one another are located in the same object plane by virtue of these objects being represented with similar contrast. By contrast, if one of the two objects is a phase object and the other object is an amplitude object, a viewer finds it very difficult to determine when the two elements are situated in the same object plane since phase objects, on account of their low contrast, cannot be recognized or can only be recognized with great difficulty in the object plane in which an amplitude object is represented in focus, and amplitude objects are represented out of focus in the object plane in which a phase object can be recognized. For example, should the phase object be a lens fragment to be removed or a tear edge of the capsular bag of the crystalline lens to be gripped and the amplitude object be a phaco tip to be led to the lens fragment or micro-tweezers to be led to the tear edge, it would be helpful if it were possible to communicate to the treating physician how they must move the corresponding medical instrument in relation to the respective phase object.

In an embodiment variant of the equipment according to the invention, the ascertainment of the position of the phase object along the optical axis is preceded by digital image evaluation being used to recognize the phase objects present in the imaged observation region on the basis of images from the stack of digital images. In this case, the phase objects present in the imaged observation region may for example be recognized on the basis of images from the stack of digital images in which the respective phase object has a high contrast. Then, it is subsequently possible to determine the object plane in which the contrast is minimal for each phase object. Hence, each phase object can be assigned a position along an optical axis. This embodiment variant offers the advantage that the position along the optical axis of the imaging beam path can be ascertained in automated fashion for a multiplicity of phase objects present in the observation region.

It is possible to create a three-dimensional distribution of the phase objects in the observation region should the method moreover contain an ascertainment of the positions of all recognized phase objects perpendicular to the optical axis, i.e. the positions of said phase objects within a plane perpendicular to the optical axis. Moreover, knowledge of the three-dimensional position of the phase objects allows the ascertainment of an unambiguous distance, for example of a medical instrument from the respective phase object. For example, the position of a phase object may be specified in this case by the position of its center or its centroid.

In a further configuration of the method, the extent of the recognized phase objects perpendicular and/or parallel to the optical axis is ascertained. In particular, this allows ascertainment of the length that a phase object covers along the optical axis and/or the area that the phase object covers in the plane perpendicular to the optical axis and/or the volume of the phase object. Knowledge of these parameters for example allows the creation of an accurate model of the distribution of the phase objects in an observation region. In particular, the phase objects may also be assigned a size in addition to their position. As a result, a physician is able to initially remove the largest lens fragments, for example.

The method for ascertaining the position of a phase object in an imaged observation region, at least along the optical axis of the imaging beam path, may be used within the scope of a method for assisting the three-dimensional positioning of a distal end of a medical instrument to be identified in an image of an imaged observation region, relative to a phase object present in the imaged observation region. For example, in this case the phase object may be a lens fragment, and the medical instrument may be a phaco needle. In a further example, the phase object may be a tear edge of the capsular bag of the crystalline lens, and the medical instrument may be a pair of micro-tweezers. In that case, the method for assisting the three-dimensional positioning of a distal end of a medical instrument to be identified in an image of an imaged observation region, relative to a phase object present in the imaged observation region, comprises the steps of:

ascertaining the position of the phase object, at least along the optical axis of an imaging beam path for imaging the observation region, wherein the above-described method is used.
ascertaining the position of the distal end of the medical instrument, at least along the optical axis of the imaging beam path. In this case, ascertaining the position of the distal end of the medical instrument may be realized with the aid of various methods. For example, should the medical instrument be an amplitude object, the position of the distal end of said medical instrument may be ascertained from stereoscopic images with the aid of triangulation, with the aid of OCT (OCT: optical coherence tomography), by determining the position along the optical axis for the plane in which the instrument is depicted in focus, etc. Should the medical instrument be a phase object, its position can be ascertained using the above-described method. In this case, it is sufficient for the distal end of the medical instrument to be or contain a phase object (e.g. components made of a transparent plastic) or for such a phase object to be attached to the distal end.
outputting an indicator that identifies the distance of the distal end of the medical instrument from the phase object, at least along the optical axis of the imaging beam path. Outputting the indicator may assist a physician with moving the distal end of the medical instrument to the phase object quicker than would be possible without the method described. For example, an arrow indicating the direction in which the distal end of the medical instrument needs to be moved in order to lead it to the phase object comes into consideration as an indicator. However, the indicator may also be a color gradient superimposed on the image of the observation region for example, wherein the color represents a distance from the phase object, and the distal end of the medical instrument is colored using the color corresponding to its respective distance from the phase object. On the basis of the color change during the movement of the distal end, the physician is then able to recognize whether they are moving the distal end toward the phase object or away from the latter. Moreover, the indicator need not be visual either. For example, there is the possibility of an audio indicator, for example in the form of a sequence of pulses, the frequency of which increases the closer the distal end of the medical instrument comes to the phase object until it for example represents a continuous sound when the distal end has arrived at the phase object. In principle, a tactile indicator would also be possible, for example by means of a vibrating element that is attached to a body region of the physician and whose frequency of vibration correlates with the distance of the distal end of the medical instrument from the phase object.

Should the observation region be a segment of an eye and should lens fragments be present as phase objects and a phaco needle be present as a medical instrument, the method may additionally contain the following steps:
a) selecting a first (single) lens fragment and superimposing highlighting for the first selected lens fragment, wherein the indicator is configured such that it renders identifiable the distance of the distal end of the phaco needle from the selected and highlighted first lens fragment, at least along the optical axis of the imaging beam path.
b) should the lens fragment for which highlighting was superimposed previously no longer be present, selecting a subsequent (single) lens fragment and superimposing highlighting for the subsequent lens fragment, wherein the indicator is configured such that it renders identifiable the distance of the distal end of the phaco needle from the selected and highlighted subsequent lens fragment, at least along the optical axis of the imaging beam path.
c) repeating step b) until no lens fragment is present anymore.

Using this configuration of the method, the physician is able to lead the distal end of the phaco needle to all lens fragments in order so as to remove these in succession. In this case, the lens fragment with the greatest extent perpendicular and/or parallel to the optical axis may be selected as the first lens fragment, the lens fragment with the second largest extent perpendicular and/or parallel to the optical axis may be selected as the subsequent lens fragment and, when repeating step b), the lens fragment with the next smaller extent perpendicular and/or parallel to the optical axis may be in each case selected as the subsequent lens fragment. This allows the physician to initially remove the largest lens fragment and then progress to ever smaller lens fragments until all lens fragments have been removed. In this way, the physician may progress from the most relevant lens fragment to the least relevant lens fragment. Moreover, the controller may be designed to superimpose highlighting for a lens fragment only if the extent of the lens fragment perpendicular to the optical axis and/or in parallel reaches or exceeds a minimum extent. In this case, the minimum extent may be chosen in view of all lens fragments not attaining this minimum extent being those that need not be removed from a medical point of view. In this way, it is possible to provide the physician with an indication of which lens fragments must be removed in any case. In an alternative, in the selection of the lens fragment to be removed next, it is also possible to select the lens fragment that exceeds a minimum extent and is situated at a small distance from the phaco needle so that the physician need not move the phaco needle much. This can reduce the duration of the cataract operation.

Moreover, the invention provides an optical observation apparatus. The latter comprises:
at least one imaging beam path for imaging an observation region that contains at least one phase object, i.e. an object that does not change or only minimally changes the amplitude of the light passing therethrough. Should the observation region be an eye, the phase object may be e.g. a lens fragment or a tear edge of the capsular bag of the lens capsule in the case of capsulorhexis. However, a transparent part of a medical instrument may also be a phase object.
at least one digital image sensor for recording digital images of the observation region, which each image a plane in the observation region that is conjugate to the image plane of the at least one image sensor. At least two image sensors may be present if stereoscopic images are to be obtained for the observation region, in each case at least one image sensor for each partial stereoscopic image. Should two image sensors be used, it is also possible that only one of the image sensors is used to record the image stacks. Alternatively, both image sensors might also record image stacks with different conjugate planes in the object space, with the result that the position of the phase objects may be determined within a short time period of with greater accuracy.
a variation unit that is designed to vary the position of the conjugate plane in the observation region along the optical axis and to prompt the at least one digital image sensor to record a stack of digital images of the observation region with different positions of the conjugate plane in the observation region. In this context, the variation unit may comprise at least one of the following devices: (i) a displacement device for displacing the at least one digital image sensor along the optical axis, (ii) at least one optical element for introducing a defocus into the imaging beam path leading to the at least one image sensor. Such a defocus leads to the plane in the observation region conjugate to the image sensor being displaced even though the image sensor itself is not moved. For example, an optical element for introducing a defocus may be an optical element with two elements that are displaceable relative to one another in a direction perpendicular to the optical axis, wherein the defocus depends on the relative displacement of the elements with respect to one another (this is known as an Alvarez element), or a liquid lens whose refractive power may be modified, for example by the application of a voltage, by the application of a mechanical force, by the excitation of acoustic standing waves, etc. However, the at least one optical element may also be the objective of a camera with the digital image sensor. Setting the objective may also displace the plane in the observation region conjugate to the image sensor without the image sensor itself being moved. In this case, a stack of digital images is considered to be a plurality of digital images that in each case image planes in the observation region that differ from one another in terms of their position along the optical axis.
an image evaluation unit that is designed to ascertain the position of the at least one phase object along the optical axis (z-position) from the stack of digital images. To this end, the image evaluation unit may be designed to ascertain the contrasts of the at least one phase object in the images from the stack of digital images and to ascertain the position of the conjugate plane in the observation region along the optical axis for that digital image from the stack of digital images in which the phase object has the lowest contrast. The image evaluation unit is also designed to assign the position of the conjugate plane of that image in which the phase object has the lowest contrast to the at least one phase object as the position of the latter along the optical axis.

The optical observation apparatus according to the invention allows the above-described method according to the invention to be performed and hence the realization of the advantages obtainable by the method according to the invention. Therefore, reference is made to these advantages. Using the possible further configurations of the optical observation apparatus described below, it is accordingly possible to realize the possible further configurations of the method according to the invention and hence the advantages linked to the further configurations of the method according to the invention. As regards the advantages of the possible further configurations of the optical observation apparatus, reference is made to the description of the possible further configurations of the method according to the invention.

In a configuration of the optical observation apparatus, the digital image evaluation unit is designed to recognize the phase objects present in the imaged observation region on the basis of images from the stack of digital images before the ascertainment of the position of the at least one phase object along the optical axis. To this end, the image evaluation unit may for example be designed to recognize the phase objects on the basis of images from the stack of digital images in which the respective phase object has a high contrast.

Moreover, in a further configuration, the optical observation apparatus may be designed to ascertain the positions of the at least one phase object, in particular of all recognized phase objects, perpendicular to the optical axis. For example, the position of a phase object may be specified in this case by the position of its center or its centroid.

In yet a further configuration, the optical observation apparatus may moreover be designed to ascertain the extent of the at least one phase object, in particular of all recognized phase objects, perpendicular and/or parallel to the optical axis.

In yet a further configuration, the optical observation apparatus may moreover comprise:
an ascertainment unit for ascertaining the position of the distal end of a medical instrument such as a phaco needle, a pair of micro-tweezers, etc., at least along the optical axis of the imaging beam path. Different methods may be used to ascertain the position of the distal end of the medical instrument. For example, the ascertainment unit may be configured to ascertain the position of the distal end of the medical instrument on the basis of a triangulation that is based on stereoscopic images showing the distal end of the medical instrument. Alternatively, the ascertainment unit may be configured to ascertain the position of the distal end of the medical instrument with the aid of OCT (OCT: optical coherence tomography). In yet a further alternative, the ascertainment unit may be configured to ascertain the position of that plane along the optical axis in which the distal end of the instrument is depicted in focus, and to assign the position of this plane to the distal end of the medical instrument should the distal end be an amplitude object. Should the distal end of the medical instrument be a phase object or should a phase object at the distal end be arranged in the vicinity of the distal end, the ascertainment unit may be designed to ascertain the position of the distal end of the medical instrument using the above-described method for ascertaining the position of the phase object in an imaged observation region.
an information device for generating an indicator that identifies the distance of the tip of the medical instrument from the phase object, at least along the optical axis of the imaging beam path.
a superposition device for superimposing the indicator onto an image recorded with the aid of the at least one digital image sensor. Possible configurations of the indicator were described with reference to the method according to the invention. Reference is made to the corresponding passages.

Should lens fragments be present as phase objects and a phaco needle be present as a medical instrument, the optical observation apparatus in yet a further configuration may additionally comprise a controller that is connected to the digital image evaluation unit, the information device and the superposition device for the exchange of signals. In this case, the controller is also configured:
to select a first lens fragment from the lens fragments recognized by the digital image evaluation unit, to prompt the superposition device to highlight the selected (single) first lens fragment and to prompt the information device to configure the indicator such that it renders identifiable the distance of the distal end of the phaco needle from the selected and highlighted first lens fragment, at least along the optical axis of the imaging beam path;
should the previously selected lens fragment no longer be present, to select a subsequent lens element from the lens fragments recognized by the digital image evaluation unit, to prompt the superposition device to highlight the selected subsequent (single) lens fragment, to prompt the information device to configure the indicator such that it renders identifiable the distance of the distal end of the phaco needle from the selected and highlighted subsequent lens fragment, at least along the optical axis of the imaging beam path, and to repeat this procedure until no lens fragment is present anymore.

In yet a further configuration of the optical observation apparatus, the controller is configured to select as the first lens fragment the lens fragment that has the greatest extent perpendicular and/or parallel to the optical axis and to select as the subsequent lens fragment the respective lens fragment that has the next smaller extent perpendicular and/or parallel to the optical axis.

In yet a further configuration of the optical observation apparatus, the controller is designed to prompt the superposition device to highlight a lens fragment only if its extent perpendicular and/or parallel to the optical axis reaches or exceeds a minimum extent.

According to the invention, a computer-implemented method for determining the position of a phase object in an observation region is also provided, said computer-implemented method, when executed on a computer, prompting said computer to ascertain the position of the phase object along the optical axis from a stack of digital images of the observation region obtained using at least one digital image sensor, wherein the images of the stack each contain image representations of the phase object and have been recorded at different positions of a plane in the observation region that is conjugate to the image plane of the at least one image sensor. In this case, the method, when executed on a computer, may prompt the computer
to ascertain the contrasts of the phase object in the images from the stack of digital images,
to determine the position of the conjugate plane in the observation region along the optical axis for that digital image from the stack of digital images in which the phase object has the lowest contrast and
to assign the position of this conjugate plane to the phase object as the position of the latter along the optical axis.

The computer-implemented method according to the invention may find use within the scope of the above-described method according to the invention for ascertaining the position of a phase object in an imaged observation region, at least along the optical axis of an imaging beam path, for imaging the observation region in order, once the stack of digital images has been recorded, to ascertain the position of the phase object along the optical axis from said digital images. It thus assists with realizing the advantages obtainable by the method according to the invention. Therefore, reference is made to the above-described advantages.

Moreover, a computer program having instructions that, when executed on a computer, prompt said computer to carry out the computer-implemented method according to the invention, a computer-readable storage medium with data stored thereon, said data containing instructions that, when executed on a computer, prompt said computer to carry out the computer-implemented method according to the invention and a data processing unit having a memory, a processor and, stored in the memory, a computer program having instructions that can be executed by the processor and, when executed by the latter, prompt said processor to carry out the computer-implemented method according to the invention are also provided.

Further features, properties and advantages of the present invention will become apparent from the following description of exemplary embodiments with reference to the accompanying figures.

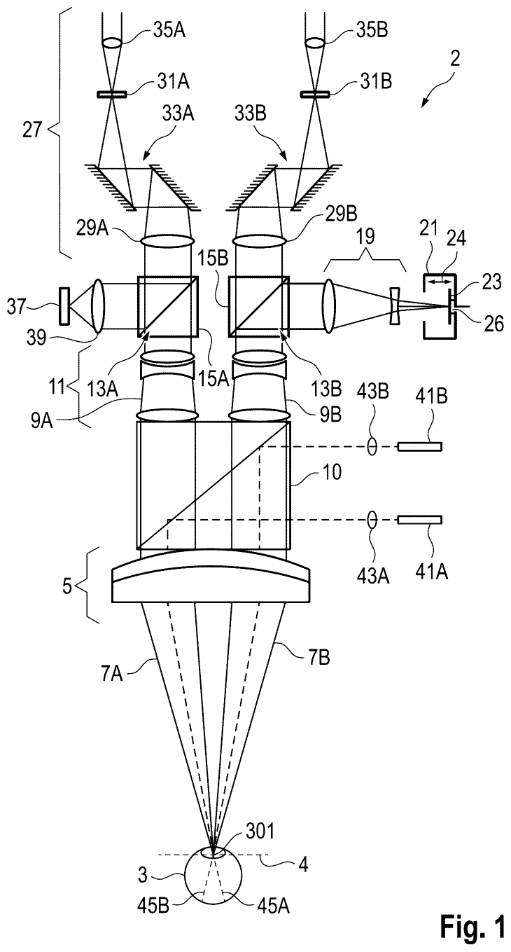

FIG. 1 schematically shows the structure of a surgical microscope having a sensor that is displaceable along the optical axis and serves to record a digital image.

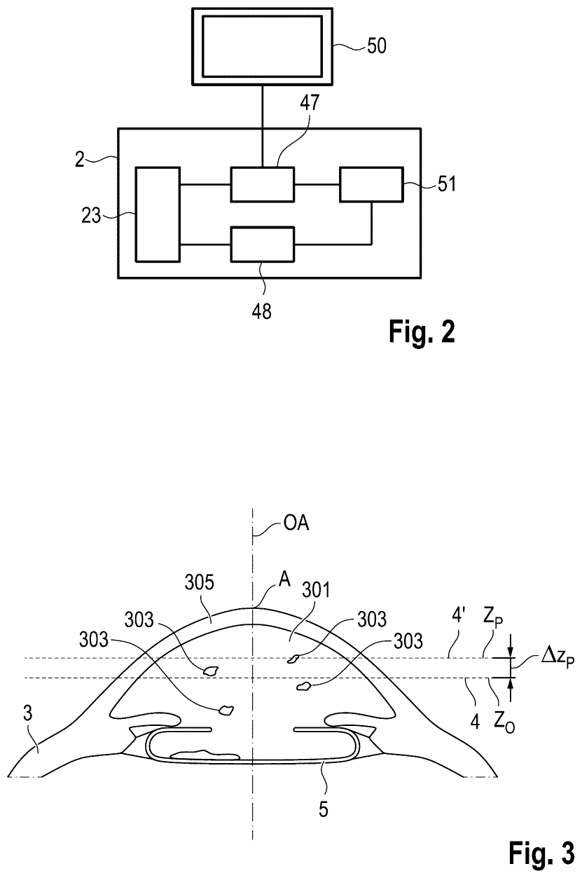

FIG. 2 shows further components that are integrated in or assigned to the surgical microscope from FIG. 1 in terms of the signaling.

FIG. 3 shows a section through an anterior chamber of the eye with lens fragments.

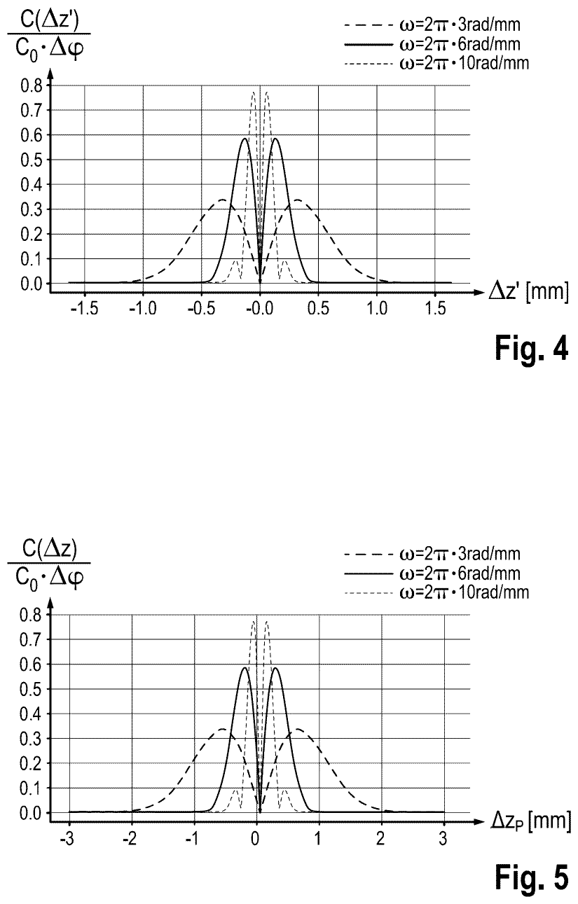

FIG. 4 shows the contrast of lens fragments in the anterior chamber of the eye in an image obtained using the surgical microscope from FIG. 1, plotted against the sensor position.

FIG. 5 shows the contrast of lens fragments in the anterior chamber of the eye in an image obtained using the surgical microscope from FIG. 1, plotted against the position of the plane in the anterior chamber of the eye conjugate to the sensor plane.

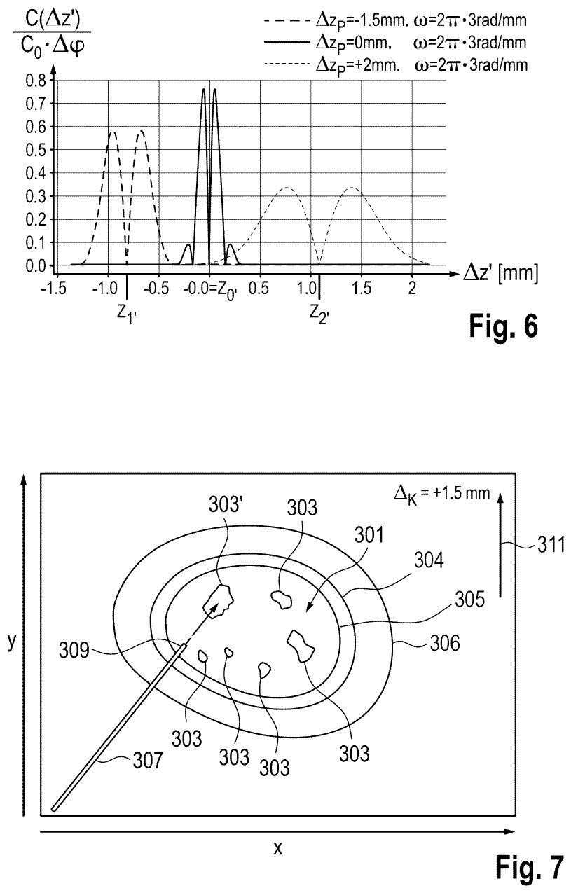

FIG. 6 shows the contrast of lens fragments situated at different positions in the anterior chamber of the eye along the optical axis of the imaging system, plotted against the sensor position.

FIG. 7 shows a first example for the output of an indicator that represents the distance of the distal end of a medical instrument from a phase object, at least along the optical axis.

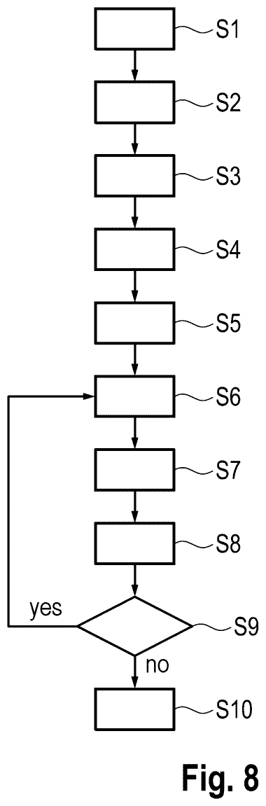

FIG. 8 shows a flowchart of a method for assisting the physician with guiding the distal end of a phaco needle to lens fragments.

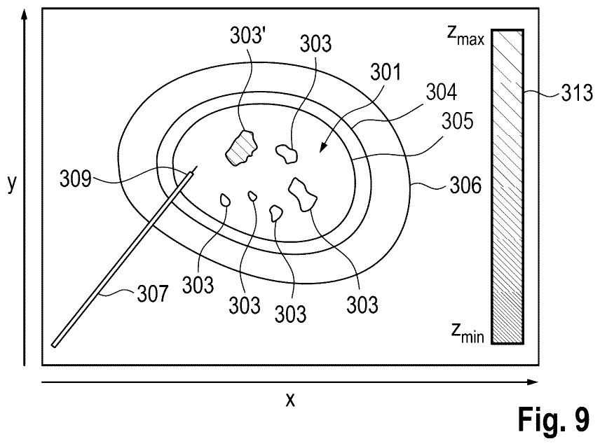

FIG. 9 shows a second example for the output of an indicator that represents the distance of the distal end of a medical instrument from a phase object, at least along the optical axis.

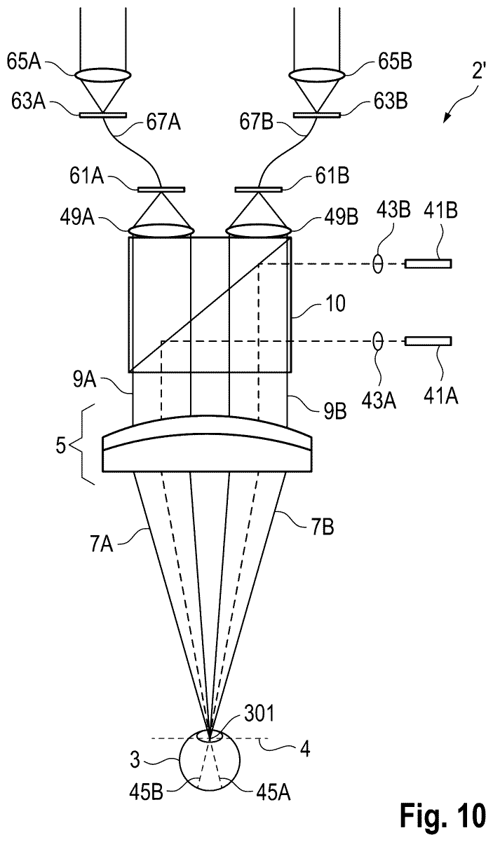

FIG. 10 schematically shows the structure of a surgical microscope having image sensors for recording digital images, in front of which liquid lenses are arranged.

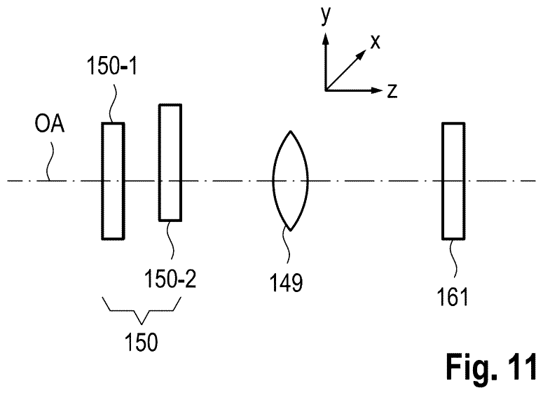

FIG. 11 shows, with optics components moved perpendicular to an optical axis, an alternative to the liquid lenses from FIG. 8.

The basic structure of a surgical microscope 2 that, as optical observation apparatus, can be used to carry out the present invention is explained below with reference to FIGS. 1 and 2.

As essential component parts, the surgical microscope 2 shown in FIG. 1 comprises an objective 5 that should face an observation region 301 and may be designed as an achromatic or apochromatic objective in particular. In the present exemplary embodiment, the observation region 301 is the anterior chamber of the eye in an eye 3. In the present exemplary embodiment, the objective 5 consists of two partial lenses that are cemented to one another. An object plane 4 of the observation region 301 to be imaged is arranged in the focal plane of the objective 5 such that a beam emanating from the object plane 4 is imaged at infinity by the objective 5. In other words, a divergent beam 7 emanating from the object plane 4 is converted into a parallel beam 9A, 9B during its passage through the objective 5. The surgical microscope is a stereoscopic microscope, i.e. the observation beam path comprises two stereoscopic partial beam paths, in which two divergent component beams 7A, 7B emanating from an object point located on the object plane 4 are converted by means of the main objective 5 into two component beams 9A, 9B that extend in collimated, i.e. parallel, fashion between the objective 5 and beam splitter 10.

The beam splitter 10 is arranged on the observer side of the objective 5. This beam splitter 10 is a large beam splitter, i.e. both component beams 9A, 9B pass therethrough, and it serves to input couple the illumination light in the direction of the observation region 301.

The beam splitter 10 is followed by a magnification changer 11 which may be designed either as a zoom system for changing the magnification factor in a continuously variable manner, as in the illustrated exemplary embodiment, or as what is known as a Galilean changer for changing the magnification factor in increments. In a zoom system, which as illustrated in FIG. 1 may be constructed from e.g. a lens combination having three lenses, the two object-side lenses may be displaced in order to vary the magnification factor. In actual fact, however, the zoom system also may comprise more than three lenses, for example four or more lenses, in which case the outer lenses then may also be arranged in a fixed manner. In a Galilean changer, by contrast, there are a plurality of fixed lens combinations which represent different magnification factors and which can be introduced into the beam path in alternation. Both a zoom system and a Galilean changer convert an object-side parallel beam into an observer-side parallel beam with a different beam diameter. In the present exemplary embodiment, the magnification changer 11 is part of the binocular beam path of the surgical microscope 1, i.e. it comprises a dedicated lens combination for each stereoscopic component beam 9A, 9B of the surgical microscope 2. In the present embodiment, a magnification factor is set by means of the magnification changer 11 by way of a motor-driven actuator (not depicted) which, together with the magnification changer 11, is part of a magnification changing unit for setting the magnification factor.

The magnification changer 11 is adjoined on the observer side by an interface arrangement 13A, 13B, by means of which external apparatuses may be connected to the surgical microscope 2 and which comprises beam splitter prisms 15A, 15B in the present exemplary embodiment. However, other types of beam splitters may also be used in principle, for example partly transmissive mirrors. In the present embodiment, the interfaces 13A, 13B serve to output couple a beam from the beam path of the surgical microscope 2 (beam splitter prism 15B) and to input couple a beam into the beam path of the surgical microscope 2 (beam splitter prism 15A).

With the aid of a display 37, e.g. a digital mirror device (DMD) or an LCD display, and an associated optics unit 39, the beam splitter prism 15A in the partial beam path of the component beam 9A serves in the present embodiment by way of the beam splitter prism 15A to reflect information or data for a viewer into the partial beam path of the component beam 9A. A camera optics unit 19 with a camera 21 fastened thereto, said camera being equipped with an electronic image sensor 23, e.g. with a CCD sensor or a CMOS sensor, is arranged at the interface 13B in the partial beam path of the other component beam 9B. An electronic and, in particular, digital image of the tissue can be recorded in the vicinity of the object plane 4 using the camera 21. In the present exemplary embodiment, the image sensor 23 is arranged so as to be displaceable along the optical axis, as indicated by the double-headed arrow 24. In the present exemplary embodiment, at least one piezo element 26 is used to displace the image sensor 23; the thickness of said piezo element can be modified by the application of a voltage, and so different positions of the image sensor 23 may be set along the optical axis with the aid of suitable voltages. Should the intention be to record stereoscopic images, the beam splitter prism 15A may be designed in such a way that, instead of using said beam splitter prism 15A to reflect information or data into the partial beam path of the component beam 9A, a beam is also output coupled therewith, and a camera may be arranged in said partial beam path for the purpose of recording digital images, like in the other stereoscopic partial beam path. In that case, this camera is equipped with an image sensor 23 that is displaceable along the optical axis, like the camera 21 described above in relation to the other partial beam path. If information or data should also be superimposed in addition to that, there is the option of providing on the image side of the interface arrangement 13A, 13B a further interface arrangement with beam splitter prisms by means of which it is then possible to reflect information or data into the respective partial beam path.

In the exemplary embodiment illustrated, the interface 13 is adjoined by a binocular tube 27 on the observer side. This has two tube objectives 29A, 29B that focus the respective parallel beam 9A, 9B on an intermediate image plane 31, i.e. image the object plane 4 in the observation region 301 onto the respective intermediate image plane 31A, 31B. Finally, the intermediate images situated in the intermediate image planes 31A, 31B are in turn imaged at infinity by eyepiece lenses 35A, 35B, and so a viewer can view the intermediate images with relaxed eyes. Moreover, an increase in the distance between the two component beams 9A, 9B is implemented in the binocular tube by means of a mirror system or by means of prisms 33A, 33B in order to adapt said distance to the interocular distance of the viewer. In addition, image erection is carried out by the mirror system or the prisms 33A, 33B.

The surgical microscope 2 also is equipped with a piece of illumination equipment, by means of which the observation region 301 can be illuminated with illumination light. In the exemplary embodiment shown in FIG. 1, this illumination equipment is designed to implement coaxial illumination. To this end, it comprises two light sources, which are the output ends of two light guides 41A, 41B in the exemplary embodiment illustrated. By way of the beam splitter 10, the illumination beams emanating from the exit ends are deflected toward the observation region 301 in a manner coaxial with the stereoscopic observation beams 7A, 7B, 9A, 9B. In the process, illumination optics units 43A, 43B shape the illumination beams such that each illumination beam forms illumination spots 45A, 45B on the retina of the eye 3. Reflected and/or scattered light emanating from these illumination spots 45A, 45B then forms illumination light which emanates from the interior of the eye and which is used to illuminate the anterior chamber of the eye, in which the object plane 4 to be imaged is situated, for the respective stereoscopic partial beam paths. Since the light reflected and/or scattered off the retina has a reddish color, this type of illumination is also referred to as red reflex illumination. The illumination spot 45B in particular is relevant to the images which were recorded by the image sensor 23 and generated on the basis of the component beam 7B, 9B only.

With the aid of the surgical microscope 2 shown in FIG. 1 it is possible to carry out the method according to the invention for ascertaining the position of a phase object in an imaged observation region 301, at least along the optical axis of the imaging beam path. In addition to the components of the surgical microscope 2 described in relation to FIG. 1, a controller 47 (see FIG. 2) that is connected to the camera 21 for signal transfer purposes is present to this end and acts on the at least one piezo element 26 of the camera 21 in order to set a position of the image sensor 23 along the optical axis. Moreover, the controller 47 controls the camera 21 such that the latter records a stack of digital images, with each image in the stack corresponding to a different position of the image sensor 23 along the optical axis.

Moreover, FIG. 2 shows an image evaluation unit 48 that is connected to the controller 47 and the camera 21 for signal transfer purposes and that, following a signal from the controller 47, receives the stack of digital images from the camera 21 and evaluates this stack in order to ascertain the positions of phase objects in the observation region 301, the positions of lens fragments in the anterior chamber of the eye in the present exemplary embodiment, along the optical axis.

Each of the controller 47 and/or the image evaluation unit 48 may be part of the surgical microscope 2 itself or be part of a data processing unit, for example a PC, assigned to the surgical microscope 2. They may be implemented as application-specific integrated circuits (ASICs) or as software, the latter especially when they are part of a data processing unit assigned to the surgical microscope 2. In the case of integration into the surgical microscope 2 itself, there is the option of integrating the controller 47 and/or the image evaluation unit 48 into the surgical microscope as application-specific integrated circuits or as software should the surgical microscope be equipped with a general purpose processor that can be programmed by means of suitable software so that it performs the function of the controller 47 and/or the image evaluation unit 48.

A procedure that will be explained below on the basis of FIGS. 3 to 6 is suitable for determining the position of a phase object along the optical axis. FIG. 3 depicts an eye 3, in particular the anterior chamber 301 of the eye, as observation region 301. The optical axis OA of the surgical microscope, the object plane 4 in the anterior chamber 301 of the eye conjugate to the image sensor 23 and lens fragments 303 present in the anterior chamber 301 of the eye as phase objects are also depicted. Within the scope of the explanations given in relation to determining the position of a phase object along the optical axis, the position z_{P} of a phase object along the optical axis is specified in the form of a z-coordinate that represents a position along the optical axis OA of the imaging beam path in the surgical microscope 2 that extends from the object plane 4 to the image sensor 23. A reference position of the object plane 4 in the region of the anterior chamber of the eye is given by the coordinate z₀, and so the object plane 4 is assumed below to be fixed at the coordinate z₀. Then, positions of lens fragments 303 may be specified in relation to this object plane 4. A reference position of the plane of the image sensor 23 is described by the coordinate z′₀. Should the position of the image sensor 23 vary, then it is possible to specify the location z′ of the image sensor relative to this reference position z₀′ as Δz′=z′−z₀′. The plane at the reference position z′₀ of the image sensor 23 is also referred to as sensor reference plane below.

Should an image of the object plane 4 be generated in the sensor reference plane, a divergent beam emanating from a point in the object plane 4 is focused by the optical imaging system onto a point into the sensor reference plane at the location z′₀, within the scope of what is possible given the aberrations of the respective optical imaging system. The object plane 4 and the sensor reference plane are therefore conjugate planes. With the aid of the at least one piezo element 26, the image sensor 23, and hence the position z′ of the plane of the image sensor 23, may be displaced along the optical axis relative to the reference position z′₀. On account of the displacement of the plane of the image sensor 23, the position z of the plane 4′ in the anterior chamber of the eye conjugate to this plane is also displaced relative to the object plane 4 with the reference position zo. In other words, the coordinate z of the conjugate plane 4′ can be changed relative to the object plane 4 in the anterior chamber of the eye by changing the coordinate z′ of the plane of the image sensor 23. In this case, the location of the origin of the coordinate system for the z-coordinate is irrelevant. All that is important in this context is that the position of the observation region 301 is known in relation to the imaging system such that a position provided in relation to the imaging system may be linked to a position in the observation region 301. For example, this link may be realized with the aid of a navigation system that captures both the position of the observation region 301 and the position of the surgical microscope 2, and hence of the imaging system, in the same coordinate system. Alternatively, there is also the option of ascertaining the position of the observation region 301 in relation to the surgical microscope 2 and hence in relation to the imaging system on the basis of stereoscopic images obtained by the surgical microscope 2. In the present exemplary embodiment, the origin is located at the reference position z₀, which is situated approximately at the center of the anterior chambers 301 of the eye. Hence, the position of a phase object 303 along the optical axis OA of the imaging beam path is ascertained in relation to the reference position zo of the object plane 4, specifically from the difference Δz_{P}=Z_{P}−Z₀ between its coordinate z_{P} and the coordinate z₀ of the reference position of the object plane 4. In this case, the orientation of the optical axis is defined such that it points from the macula in the direction of the cornea. Accordingly Δz_{P}>0 represents a position that is located in the direction toward the imaging optics unit in comparison with the reference position of the object plane 4, and Δz_{P}<0 represents a position that is located in the direction toward the macula in comparison with the reference position of the object plane 4. In this case, the parameter Δz_{P} corresponds to a parameter Δz′ that may be interpreted as a position in relation to the reference position Z₀′ of the image sensor 23 and hence also as a defocus in relation to the reference position of the object plane 4, and so the parameter Δz_{P} also represents a defocus. In other configurations of the invention, the origin of the coordinate system for the z-coordinate may also be located at other locations along the optical axis of the imaging system, for example at the object-side lens vertex of the main objective 5 of the surgical microscope 2 or at the apex A of the cornea 305.

If the instrument tip comprises a phase object, then the lens fragments 303 may also be detected directly relative to the instrument tip, and the position of the observation region 3 in relation to the imaging system need not be known.

In optics, it is known that the magnification M′, which arises as the quotient of image size and object size, and the longitudinal magnification are related. According to this known relationship, an image sensor at the location Δz′ relative to the sensor reference plane is in a conjugate plane 4′ to a lens fragment with the coordinate z_{P} when the following equation 1 is satisfied:

$$Δ {z}^{′} = Δ {z}_{P} \cdot \frac{{M}^{{′}^{2}}}{η} ,$$

where η represents the quotient n/n′ of the refractive index n in the object space and the refractive index n′ in the image space. Hence, the equation for the contrast C(Δz′_{P}) as a function of the sensor position Δz′_{P} in the image space according to equation (19) in US 2015/0002814 A1 can be rewritten as equation 2 below, in which the contrast C depends both on the position AΔz_{P} of the phase object in the object space and on the sensor coordinate Δz′:

$$C ( Δ {z}_{tot} ) = {C}_{0} \cdot \vert ΔΦ \cdot exp ( - {π}^{2} \cdot {α}^{2} \cdot Δ {{z}_{tot}}^{2} \cdot {ω}^{2} ) \cdot sin ( \frac{π \cdot Δ {z}_{tot} \cdot λ \cdot {ω}^{2}}{{M}^{{′}^{2}}} ) \vert$$

$$where Δ {z}_{tot} = Δ {z}_{P} - \frac{Δ {z}^{′} \cdot η}{{M}^{{′}^{2}}} .$$

In this case:

$$\frac{Δ {z}^{′} \cdot η}{{M}^{{′}^{2}}}$$

represents the conversion of the distance Δz′ of the image sensor plane from the sensor reference plane into a distance between the plane 4′ that is conjugate to the image sensor plane and the reference position of the object plane 4 in the spatial domain.
Co represents a constant of proportionality.
ΔΦ represents the phase shift, i.e. the phase shift of the light resulting from the passage through the phase object vis-à-vis the passage of light through the surrounding medium.
α represents the divergence half angle, with which phase objects are illuminated by the illumination spot on the retina. The following applies:

$$α = arctan \frac{δ}{L} ,$$

where δ represents the diameter of the illumination spot on the retina and L represents the distance between the illumination spot and the phase object. Since the images recorded by the image sensor 23 in the exemplary embodiment according to FIG. 1 are merely generated on the basis of the component beam 7B, 9B, the illumination spot 45B in particular is relevant here.
ω represents the spatial frequency of the phase object ΔΦ·cos(ω·χ). In the case of an irregular phase object, ω essentially represents the inverse of the spatial extent of the phase object.
λ represents the wavelength of the red reflex illumination.

Equation 2 thus describes the contrast of a phase object with a coordinate Δz_{P} on the image sensor at position Δz′. It is possible to identify that the contrast disappears in the region Δzₜₒₜ=0 mm, since the sine function in that case assumes a value of 0 in equation 2. As the absolute value |Δzₜₒₜ| increases, the contrast does as well up to a maximum value.

FIGS. 4, 5 and 6 show exemplary contrast curves; in this case, the refractive index in the object space is n′=1.33, the refractive index in the image space is n=1, the quotient is

$$η = \frac{n}{{n}^{′}} = 1.33 ,$$

the magnification is M′=0.85, the illumination spot diameter is δ=0.8 mm, the distance between the illumination spot and the phase object is L=21 mm and the divergence half angle is

$$α = arctan \frac{δ}{L} = 0.0193 .$$

For phase objects with different spatial frequencies ω, FIGS. 4 and 5 each show the contrast, normalized to the factor C₀ΔΦ, as a function of sensor position Δz′ in the case of a position Δzₚ=0 mm of the phase object (FIG. 4) and the normalized contrast as a function of position Δz_{P} of the phase object for the sensor position Δz′=0 mm (FIG. 5). What may be gathered from the figures is that the contrast of the phase object drops to zero or a value close to zero when, given the position Δz_{P}=0 mm of the phase object, the image sensor is situated at the sensor reference plane with Δz′=0 mm, and hence zₜₒₜ=0 mm applies, i.e. the phase object is situated in the object plane 4 that is imaged onto the sensor reference plane of the image sensor 23 by means of the imaging beam path. By contrast, if the phase object is at a position Δz_{P} away from the object plane 4 that is imaged onto the sensor reference plane of the image sensor 23 by means of the imaging beam path, then zₜₒₜ#0 mm, and the contrast increases up to a maximum contrast before it drops again as the value zₜₒₜ increases. The fact that a positive contrast is present in each case at both zₜₒₜ<0 mm and zₜₒₜ>0 mm in FIGS. 4 and 5 is due to only the absolute value being considered in equation 2. However, there is in fact a contrast reversal upon the passage through the focal plane, and so the phase object will be represented darker than the surroundings on one side of the focal plane and brighter than the surroundings on the other side of the focal plane.

The maximum contrast C, which has been normalized to the factor C₀ΔAΦ, and the values Δzₜₒₜ at which the maximum contrast occurs depend on the value of the spatial frequency w of the phase object. The higher the spatial frequency ω of the phase object, the lower the absolute value of the value Δzₜₒₜ at which the maximum contrast occurs, and the higher the maximum contrast is as well (cf. FIG. 4). For example, a phase object with a middling spatial frequency (solid line in FIGS. 4 and 5) exhibits its maximum contrast at a sensor position of approx. Δz′=±0.14 mm. By contrast, the position Δz_{P} of this phase object in the object space is at approximately ±0.24 mm and hence greater than in the image space by approx. a factor of

$$\frac{η}{{M}^{{′}^{2}}} = \frac{1.33}{{0.85}^{2}} \approx 1.84 .$$

The factor by which the defocus Δz_{P} in the object space is greater than the defocus Δz′_{P} in the image space is determined in this case by the inverse of the scaling factor M′²/η in equation 1. FIGS. 4 and 5 make it clear that the same image information can be obtained, independently of whether the position Δz_{P} in the object space or the sensor position Δz′ in the image space is used.

FIG. 6 shows the contrast in the plane of the image sensor 23 for three different phase objects, which are situated at different coordinates Δz_{P} and have different spatial frequencies ω. The first phase object has a large spatial frequency relative to the other two phase objects, the second phase object has a middling spatial frequency relative to the other two phase objects and the third phase object has a small spatial frequency relative to the other two phase objects. The first phase object with the large spatial frequency (solid line in FIG. 6) has a position Δz_{P}=0 mm in the object space and is thus situated on the object plane 4 of zero. Accordingly, this phase object has a normalized contrast of zero or near zero at the sensor position Δz′=0 mm, i.e. when the image sensor is situated in the sensor reference plane z₀′.

The second phase object with the middling spatial frequency (depicted using dashed lines in FIG. 6) is situated at the position Δz_{P}=−1.5 mm. By displacing the image sensor 23, its position Δz′ along the optical axis OA can be modified until a position Δz′₁ is reached at which the normalized contrast has dropped to zero or close to zero; in the present example, this is the case for a displacement of the image sensor 23 of approx. −0.8 mm. This is because ΔZₜₒₜ=0 mm is obtained by displacing the position z′ of the plane of the image sensor 23 into the position z′₁, and the contrast disappears. In this case, the sensor position Δz₁′ at which the contrast minimum is present can be calculated as

$$Δ {z}_{1}^{′} = Δ {z}_{P} \cdot \frac{{M}^{{′}^{2}}}{η}$$

using equation 1. Given an assumed inverse of the factor M′²/η of 1.84, the displacement of the plane of the image sensor 23 of Δz′₁˜−0.8 mm corresponds to a position Δz_{P}˜−0.8 mm·1.84˜−1.5 mm of the phase object vis-à-vis the object plane 4. Hence, the position z₁ has been displaced vis-à-vis the position z₀ by −1.5 mm.

The third phase object with the small spatial frequency (depicted using dotted lines in FIG. 6) is situated at a position Δz_{P}=2 mm. The contrast disappears when the image sensor is situated at the position Δz′₂=2 mm/1.84˜1.1 mm. Thus, if a vanishing contrast of the lens fragment is measured at the sensor coordinate Δz′₂=1.1 mm, it is known that the associated lens fragment is at the coordinate Δz_{P}=2 mm.

It is thus possible to ascertain the Δz_{P} position of a phase object in the object space by virtue of ascertaining the Δz∝ position of the plane of the image sensor 23 in the image space at which the normalized contrast is zero or close to zero. In that case, the ascertained position may be assigned to the phase object as its position. In order to increase the accuracy when determining the Δz_{P} coordinate of a lens fragment, there moreover is the option of interpolating between the contrasts that were ascertained in adjacent images from the stack. For example, such an interpolation can be implemented by fitting an even polynomial to the contrast values ascertained for the images. In that case, the contrast minimum corresponds to the minimum of the polynomial. The position of the minimum of the polynomial along the optical axis OA can be calculated from the distances between the positions of the individual images. In this way, it is also possible to ascertain minima of the contrast located between the object planes represented by the images from the stack of digital images. In an alternative, the interpolation can also be implemented by virtue of equation 2 for the contrast being fitted to the measured contrast. In this case, the fact that the contrast becomes minimal because the phase object is situated in the conjugate plane 4′ of the imaging system and not because, for instance, there is a very large distance Δz′_{P} in the image space can be identified by virtue of the contrast increasing independently of the direction of displacement of the image sensor 23. Moreover, depending on the direction in which the image sensor 23 is displaced, there is a contrast reversal when the phase object is in the focal plane. The occurrence of a contrast reversal may also be used to determine that a minimum of the contrast is present because the phase object is located in the focal plane. By contrast, if the contrast is minimal on account of an extremely high defocus Δz′_{P} in the image space, it increases only when the image sensor 23 is moved in one direction and remains at zero when the image sensor 23 is moved in the other direction. Even in the case of secondary maxima of the contrast, as may be relevant in the case of phase objects with small spatial frequencies ω in particular, it is possible to identify whether the phase object is in fact in the plane 4′ conjugate to Δz′ or whether it is at a position Δz′_{P} in the image space where there is a contrast minimum between a main maximum and a secondary maximum, for example as may happen in the case of the phase object depicted in FIG. 6 using the solid line. If the contrast increases to the same maximum value independently of the sign of the movement of the image sensor 23, the minimum of the contrast can be traced back to the fact that the phase object is in the focal plane associated with Δz′. By contrast, it is not in the focal plane should the contrast increase to a high value when the image sensor 23 is moved in one direction but only increase to a lower value when the image sensor 23 is moved in the other direction. Typically, this lower value is no more than 30% of the high value of the contrast.

To ascertain the position of phase objects, the controller 47 controls the at least one piezo element 26 of the camera 21 in such a way that the position of the image sensor 23, and hence the position of the plane of the image sensor 23, along the optical axis varies in a variation range Δz′ₘᵢₙ<0 mm<Δz′ₘₐₓ about the position z′₀ of the sensor reference plane. The frequency at which the image sensor is advanced by a position in the variation range may correspond in this case to the video frequency of the image recording and for example be located between 20 Hz and 60 Hz. Moreover, the controller 47 prompts the camera 21 to record a respective image at different positions of the image sensor in order to obtain a stack of digital images of the observation region 301 with different positions of the plane 4′ conjugate to the plane of the image sensor 23. In this sense, the controller 47 and the piezo element 26 act together as a variation unit that is designed to vary the position of the plane 4′ conjugate to the plane of the image sensor 23 in the observation region 301 along the optical axis in a variation range Δzₘᵢₙ<0 mm<Δzₘₐₓ about the reference position zo of the object plane 4 and to prompt the at least one digital image sensor 23 to record a stack of digital images of the observation region 301 with different positions of the object plane 4 in the observation region 301.

From the controller, the image evaluation unit 48 receives the stack of digital images and position data that specify the respective position of the image sensor 23, and hence the position of the plane of the image sensor 23, in the range Δz′ₘᵢₙ<0<Δz′ₘₐₓ for each recorded image in the stack. In the present exemplary embodiment, the image evaluation unit 48 then uses the images in the stack to perform a first image evaluation routine in which it recognizes the phase objects located in the variation range Δzₘᵢₙ<0<Δzₘₐₓ of the object plane 4. To this end, the first image evaluation routine analyzes the stack of digital images and fragments the latter such that each phase object is recognized. For example, recognition of the phase objects may be implemented on the basis of images in which the respective phase object has a high contrast, by virtue of edges being ascertained in the images using an edge detection algorithm. These edges represent boundaries between phase objects and the surrounding medium. On account of the fact that the stack contains images for a number of different planes 4′ which are located in a range of ΔZₘᵢₙ<0<Δzₘₐₓ, it is possible to find an image for each phase object in which the latter can be recognized with sufficient contrast. On the basis of the corresponding image, it is then also possible to use the first image evaluation routine to ascertain the position of the phase object in the plane 4′ perpendicular to the optical axis and its extent within this plane. For example, x_{P}- and y_{P}-coordinates of the centroid or center of the phase object in the plane perpendicular to the optical axis may be used as the position of a phase object in this case.

Once the phase objects were identified and their positions and extents were acquired using the first image evaluation routine, a second image evaluation routine is performed, the latter ascertaining the z_{P} coordinates of the recognized phase objects on the basis of the images from the image stack, as described above. A depth map, which represents the three-dimensional distribution of the phase objects in the observation region 301, is thus obtained as a result. At this point, attention is drawn to the fact that the ascertainment of the lateral position (x_{P}, y_{P}) and the extent of the phase objects can be omitted if it is only their coordinates z_{P} along the optical axis, i.e. a depth distribution of the phase objects, that is of interest.

For example, the described method can be used within the scope of a method that assists a physician with the positioning of the distal end of a medical instrument, which should be recognized in the image of the observation region 301, relative to phase objects situated in the observation region 301. An example where a physician needs to position a medical instrument in relation to phase objects is found in the comminution of lens fragments and the removal of the comminuted lens fragments from the anterior chamber of the eye within the scope of a cataract operation. Another example is the gripping of a tear edge of the capsular bag of the crystalline lens within the scope of a capsulorhexis. The assistance for a physician when positioning a medical instrument in relation to phase objects is described below with reference to FIGS. 3, 7 and 8 using the example of the assistance given to a physician when positioning the distal end of a phaco needle when comminuting and removing lens fragments within the scope of a cataract operation. In this case, FIG. 7 shows a plan view of the anterior chamber 301 of the eye in an eye 3, in which lens fragments 303 that are to be comminuted and removed are located, the inner edge 304 of the iris and the tear edge 305 of the capsular bag of the lens that has arisen within the scope of a capsulorhexis. The figure also shows the distal end 309 of a phaco needle 307. The distal end 309 of the phaco needle 307 is also referred to as phaco tip. FIG. 3 shows an example of a distribution of the lens fragments 303 to be comminuted and removed, along the optical axis OA of the imaging system. FIG. 8 shows a flowchart of the method for assisting the physician with guiding the distal end 309 of the phaco needle 307 to the lens fragments 303.

In a first step S1 of the method for assisting the physician with leading the distal end 309 of the phaco needle 307 to the lens fragments 303, a stack of digital images of the chamber 301 of the eye is recorded by means of the displaceable image sensor 23 of the surgical microscope 2. The recorded stack of digital images is then evaluated by the image evaluation unit 48 together with the position data that specify the respective position of the image sensor 23 for each recorded image in the stack. In a first evaluation step S2, use is made of the first image evaluation routine, which recognizes lens fragments 303 and ascertains the respective position and extent of the recognized lens fragments 303 in a plane perpendicular to the optical axis OA. In this case, a minimal extent of the lens fragments 303 may be predetermined as limit value. In this case, this limit value may be specified in particular as minimal area Amin in the xy-plane. For example, the minimal area Amin may adopt the following values: (0.4 mm)², (0.1 mm)², (0.05 mm)² or even (0.008 mm)². Lens fragments 303 that do not attain the minimal area Aₘᵢₙ are ignored over the further course of the method. In particular, the minimal area Aₘᵢₙ is predetermined in such a way that those lens fragments 303 whose area in the xy-plane does not attain the minimal area Aₘᵢₙ do not harbor disadvantageous effects if they are not removed from the chamber 301 of the eye.

In the next evaluation step S3, the second image evaluation routine uses the stack of digital images to ascertain the respective position z_{P} in the direction of the optical axis OA for each lens fragment 303 that is recognized and not ignored during the further processing, as described above. In the present exemplary embodiment, the test as to whether a determined contrast minimum can in fact be traced back to the associated lens fragment 303 being in the focal plane is implemented by checking whether there is a contrast reversal when passing through the minimum. However, it is also possible to manage without this test.

The position of the distal end 309 of the phaco needle 307 is ascertained in steps S4 and S5 after the extent of the lens fragments 303 and their position both along the optical axis and in the plane perpendicular thereto have been ascertained. It is self-evident that these steps may also be performed before or during the steps performed for the ascertainment of the position z_{P} of the lens fragments 303 in the direction of the optical axis OA. Should the distal end 309 of the phaco needle 307 be transparent such that it is also a phase object, the position of the distal end can be ascertained both along the optical axis and in a plane perpendicular to the optical axis using the same method that was also used to ascertain the position of the lens fragments 303. Nevertheless, it is possible to ascertain the three-dimensional position of the distal end 309 of the phaco needle 307 along the optical axis OA from the stack of digital images should the distal end 309 of the phaco needle 307 not be transparent and hence be an amplitude object rather than a phase object. This happens in the present exemplary embodiment.

To ascertain the position of the distal end 309 of the phaco needle 307 along the optical axis OA, in the present exemplary embodiment a third image evaluation routine ascertains, in step S4, the image sharpness with which the distal end 309 is represented in the images from the stack of digital images and finds the image in which the image sharpness is at a maximum. For the image in which the image sharpness of the distal end 309 of the phaco needle 307 is maximal, it then ascertains, in step S5, the position of the plane 4′ in the chamber 301 of the eye conjugate to the plane of the image sensor 23 from the position of the image sensor 23 assigned to this image and assigns this position to the distal end 309 of the phaco needles 307 as their position along the optical axis OA. In this case, the image sharpness may also be interpolated between the image sharpness values obtained for the individual positions of the image sensor 23 in order to allow a more accurate determination of position. For example, such an interpolation may be implemented by fitting an even polynomial to the image sharpness values. In that case, the maximum of the image sharpness corresponds to the maximum of the polynomial. The position of the maximum of the polynomial along the optical axis OA can be calculated from the distances between the positions of the individual images. Ascertainment of the position of the distal end 309 of the phaco needle 307 on the basis of the stack of digital images offers the advantage that the position is automatically ascertained in the same coordinate system as the position of the lens fragments 303.

However, there are also alternatives to ascertaining the position of the distal end 309 of the phaco needle 307 on the basis of the stack of digital images. For example, the position of the distal end 309 of the phaco needle 307 can be ascertained on the basis of stereoscopic images of the anterior chamber 301 of the eye that show the distal end 309 of the phaco needle 307, provided the utilized surgical microscope is equipped to record digital stereoscopic images. In the stereoscopic images, the distal end 309 of the phaco needle 307 has a parallax, from which it is possible to determine its position along the optical axis OA. Provided at least one of the digital image sensors used to record the stereoscopic images is also used to ascertain the position of the lens fragments 303, the position of the distal end 309 of the phaco needle 307 is also ascertained in the same reference system as the position of the lens fragments 303 in this case. Should the surgical microscope be equipped with an OCT system, there is moreover the option of ascertaining the position of the distal end 309 of the phaco needle 307 along the optical axis OA using depth data acquired with the OCT system. In this alternative, the position of the distal end 309 of the phaco needle 307 is ascertained using different equipment to the ascertainment of the position of the lens fragments 303. Therefore, care has to be taken that the position of the distal end 309 of the phaco needle 307 is specified in the same coordinate system as the position of the lens fragments 303. In yet a further alternative, there is the option of ascertaining the positions of a marker on the phaco needle 307 and a marker on the surgical microscope 2 using a navigation system. From the ascertained positions of the marker for the surgical microscope 2 and the marker for the phaco needle 307 in the coordinate system of the navigation system and from the known position of the lens fragments 303 in an internal reference system of the surgical microscope 2 it is possible to convert the position of the marker for the phaco needle 307 specified in the coordinate system of the navigation system into a position in the internal reference system of the surgical microscope 2. If the position of the distal end 309 of the phaco needle 307 is also known in relation to the marker of the phaco needle 307, the position of the distal end of the phaco needle 307 can be ascertained in the internal reference system of the surgical microscope 2 from the position of the marker for the phaco needle 307.

After the positions of the lens fragments 303 and the position of the distal end 309 of the phaco needle 307 have been ascertained, an information device 51 selects the largest lens fragment present as first lens fragment 303′ in step S6 and calculates the distance between the distal end 309 of the phaco needle 307 and the selected first lens fragment 303′, at least along the optical axis

OA, in step S7. Moreover, in step S8, the information device 51 generates a superposition image for superimposition onto the image obtained by the surgical microscope 2, said superposition image containing highlighting of the first selected lens fragment 303′ on the one hand and an indicator 311 on the other hand, the latter specifying the distance of the distal end 309 of the phaco needle 307 from the highlighted lens fragment 303′ along the optical axis OA. The information device 51 is a software or hardware unit that is connected to the image evaluation unit 48 for the purpose of receiving the information about the recognized lens fragments and to the controller 47 for the purpose of outputting the superposition image to a monitor 50, the image display on said monitor 50 also being controlled by said controller. However, it is also possible for the control of the surgical microscope 2 and the control of the image display on the monitor 50 to be performed by separate controllers. However, as software or hardware, the information device 51 may also be integrated in either of the controller 47 and the image evaluation unit 48. The monitor 50 may also be a stereo monitor. It is also possible that the display 37 of the surgical microscope 2 is used as monitor 50.

In the present exemplary embodiment, the indicator 311 is an upward or downward arrow, which is superimposed in a region of the image and which indicates whether the distal end 309 of the phaco needle 307 must be moved upward or downward. Moreover, the distance Δ_{K} by which the distal end 309 of the phaco needle 307 must be moved is also specified in the present exemplary embodiment. However, this is not mandatory. It is also possible for the length of the arrow to represent this distance. The closer the physician comes to the highlighted lens fragment 303′ with the tip 309 of the phaco needle 307, the shorter the arrow may become until the latter disappears entirely once the distal end 309 of the phaco needle 307 has reached the position z_{K}=z_{P} of the highlighted lens fragment 303′ along the optical axis OA. This can reveal to the physician that the distal end 309 of the phaco needle 307 is situated in the same plane, which extends perpendicular to the optical axis, as the highlighted lens fragment 303′ and that further movement of the distal end 309 of the phaco needle 307 toward the highlighted lens fragment 303′ need only still be implemented within this plane.

An alternative indicator that renders the distance of the distal end 309 of the phaco needle 307 from the first highlighted lens fragment 303′ along the optical axis OA identifiable is depicted in FIG. 9. In the case of this indicator, a color scale or a grayscale 313 is superimposed in a region of the obtained image of the observation region 301, said scale representing the interval [Δzₘᵢₙ, Δzₘₐₓ] in which the plane 4′ conjugate to the sensor plane can move along the optical axis OA in the object space relative to the position of the object plane 4 when ascertaining the position of the lens fragments 103. A grayscale 313 is used in the example depicted in FIG. 9. In this case, the darkest level of gray represents the position zₘᵢₙ, the brightest level of gray represents the position zₘₐₓ and the intermediate levels of gray represent corresponding positions z between zₘᵢₙ and zₘₐₓ. In that case, the highlighted lens fragment 303′ is colored with that level of gray that corresponds to its position z_{P} along the optical axis OA between zₘᵢₙ and zₘₐₓ. Accordingly, the distal end 309 of the phaco needle 307 is likewise colored in that level of gray that corresponds to its current position z_{K} along the optical axis OA. When the distal end 309 of the phaco needle 307 is moved along the optical axis OA such that its position z_{K}changes, the level of gray of its coloring changes accordingly. Then, the distal end 309 of the phaco needle 307 may be moved along the optical axis OA until its level of gray corresponds to the level of gray of the highlighted lens fragment 303′, i.e. until its position z_{K} along the optical axis corresponds to the position z_{P} of the highlighted lens fragment 303′ along the optical axis OA. This can reveal to the physician that the distal end 307 of the phaco needle 307 is located in the same plane, which is perpendicular to the optical axis OA, as the highlighted lens fragment 303′. All lens fragments 303 rather than just the highlighted lens fragment 303′ may also be colored in the level of gray that corresponds to their position along the optical axis OA. A corresponding procedure is also possible using a color scale rather than a grayscale 313.

Going beyond the indicators described, further options are revealed to a person skilled in the art as regards the configuration of an indicator that renders identifiable the distance of the distal end 309 of the phaco needle 307 from a highlighted lens fragment 303′, at least along the optical axis OA of the imaging beam path. Additionally, these indicators need not necessarily be optical indicators. For example, there is the option of specifying the distance by means of audio signals, for example by means of a sequence of pulses whose frequency increases as the distal end 309 of the phaco needle 307 comes closer to the highlighted lens fragment 303′, or by means of a sound whose pitch represents the distance.

Once the physician has guided the distal end 309 of the phaco needle 307 to the first highlighted lens fragment 303′, they may use the phaco needle 307 to comminute (if this has not yet already occurred) and aspirate said lens fragment. Then, a check is carried out in step S9 of the present exemplary embodiment as to whether further lens fragments 303 that need to be comminuted and removed are present. Should this be the case, the method returns to step S6, in which the next smaller lens fragment, which now represents the largest lens fragment present, is selected, and steps S7 and S8 are repeated for this lens fragment selected in that case. This is continued until there is a determination in step S9 that no lens fragment that needs to be comminuted and removed is present anymore. In this case, the method is terminated in step S10. In this way, the respective largest lens fragment 303 is highlighted for as long as lens fragments 303 that are not smaller than the minimum extent are still present in the anterior chamber 301 of the eye, and an indicator 311 is output for this highlighted lens element, the indicator representing the distance of the distal end 309 of the phaco needle 307 from the corresponding lens element along the optical axis OA. Even though the selection of the next lens fragment is automated in the present exemplary embodiment, there is also the option of the method only advancing to the next smaller lens fragment following a command by the physician.

Within the scope of the described method, there is the option of the check in step S9 as to whether lens fragments 303 that need to be comminuted and removed are present being prompted by a command by the physician, for example a voice command, or by the actuation of a foot or hand switch. Alternatively, there is also the option of respective image stacks being recorded at short time intervals, on the basis of which there respectively is a recognition of the lens fragments 303 present in the anterior chamber 301 of the eye and an ascertainment of their position in the anterior chamber 301 of the eye and of their extent. Hence, the method is able to independently determine that a previously present lens fragment is no longer present and select the next lens fragment.

The basic structure of an alternative surgical microscope 2′ that, as optical observation apparatus, can be used to carry out the present invention is explained below with reference to FIG. 10. This surgical microscope 2′ is a purely digital surgical microscope. The main objective 5, the illumination system 41A, 41B, 43A, 43B and the large beam splitter 10 do not differ from the corresponding elements of the surgical microscope 2 shown in FIG. 1, which is why these are denoted by the same reference signs as in FIG. 1 and are not explained again at this juncture. The two magnification changers 11 present in the surgical microscope shown in FIG. 1 are not contained in the surgical microscope 2′ described here, although they may be contained as an option.

The difference from the surgical microscope 2 of FIG. 1 lies in the fact that the surgical microscope 2′ shown in FIG. 10 does not comprise an optical binocular tube. Instead of the tube objectives 29A, 29B from FIG. 1, the surgical microscope 2′ from FIG. 10 comprises focusing lenses 49A, 49B with which the binocular observation beam paths 9A, 9B are imaged onto digital image sensors 61A, 61B. In this case, the digital image sensors 61A, 61B may be CCD sensors or CMOS sensors, for example. The images recorded by the image sensors 61A, 61B are transmitted digitally to digital displays 63A, 63B, which may be embodied as LED displays, as LCD displays or as displays based on organic light-emitting diodes (OLEDs). Like in the present example, eyepiece lenses 65A, 65B may be assigned to the displays 63A, 63B, by means of which the images displayed on the displays 63A, 63B are imaged at infinity such that a viewer can view said images with relaxed eyes. The displays 63A, 63B and the eyepiece lenses 65A, 65B can be part of a digital binocular tube; however, they can also be part of a head-mounted display (HMD) such as, e.g., a pair of smartglasses. Moreover, there is the option of representing the recorded images as stereoscopic images on a large monitor that is observed by staff in the operating theater using suitable 3-D glasses. For the purpose of differentiating the partial stereoscopic images, the latter may be represented using e.g. different polarizations of the light emitted by the monitor during the representation of the stereoscopic images on the monitor. In this case, the partial stereoscopic images can be represented on the monitor sequentially in time. Each lens of the 3-D glasses is equipped with a polarizer that only allows either the left or the right partial stereoscopic image to pass. An alternative procedure consists in configuring each partial stereoscopic image as a half image. In other words, adjacent lines on the monitor in each case represent either the left or the right partial stereoscopic image. Although this variant leads to the partial stereoscopic images having a lower line resolution, this manner of representation is not accompanied by a reduction in the image repetition rate in the case of a time-sequential representation of the partial stereoscopic images. A time-sequential representation of unpolarized partial stereoscopic images is possible in a further alternative. In that case, these partial stereoscopic images may be viewed using a pair of shutter glasses, in which the left and the right lens are switched transparent and opaque in time-synchronized fashion with the representation of the left and right partial stereoscopic images on the monitor.

The focusing lenses 49A, 49B can be displaced along an optical axis; this is equivalent to a movement of the displays 61A, 61B. Alternatively, the focusing lenses 49A, 49B are configured as lenses of variable refractive power. In the present exemplary embodiment, liquid lenses are used as lenses of variable refractive power, the refractive power of which may be modified, for example by the application of a voltage, by the application of a mechanical force, by the excitation of acoustic standing waves, etc. They are used to displace the image-side focal plane relative to the plane of the image sensors 61A, 61B. They have a reference refractive power, in which the focal plane coincides with the plane of the image sensors 61A, 61B. If the refractive power is increased vis-à-vis this reference refractive power, the image-side focal plane is displaced in front of the plane of the image sensors 61A, 61B. By contrast, if the refractive power is decreased vis-à-vis the reference refractive power, the image-side focal plane is displaced behind the plane of the image sensors. In this way, the plane 4′ conjugate to the image sensor can be displaced with regard to the object plane 4 in the object space. This displacement is equivalent to a displacement of the image sensors along their optical axis, and so the plane 4′ conjugate to the focal plane can be displaced in the observation region 301 by means of a variation in the refractive power of the focusing lenses 49A, 49B, and so the described method for ascertaining the position of a phase object in an imaged observation region 301, at least along the optical axis of an imaging beam path, may be realized by means of a variation in the refractive power of the focusing lenses 49A, 49B.

Even though FIG. 10, like FIG. 1, only depicts an achromatic lens 5 with a fixed focal length, the surgical microscope 2′ shown in FIG. 10 may comprise an apochromatic lens, like the surgical microscope 2 depicted in FIG. 1. Furthermore, FIG. 10 shows a transmission of the images recorded by the image sensors 61A, 61B to the displays 63A, 63B by means of cables 67A, 67B. Instead of in wired fashion, the images may however also be transmitted wirelessly to the displays 63A, 63B, especially if the displays 63A, 63B are part of a head-mounted display.

An alternative to the lenses 49A, 49B of variable refractive power, depicted in FIG. 10, is depicted in FIG. 11. The illustration only shows one partial beam path from FIG. 10; however, the configuration of the other partial beam path is identical. A combination of a focusing lens 149 with a constant refractive power and what is known as an Alvarez element 150 is arranged in the beam path. The wavefront of light waves can be manipulated using this Alvarez element 150. The Alvarez element 150 comprises two component elements 150-1, 150-2, which may be displaced oppositely to one another in a direction perpendicular to the optical axis OA. At least one side of each component element 150-1, 150-2 has a free-form surface, wherein the free-form surfaces are shaped identically and in a manner complementing one another such that they cancel out each other's effects if the two component elements 150-1, 150-2 are situated in a reference position in which they are not displaced relative to one another. The image-side focal plane of the focusing lenses 149 coincides with the plane of the image sensor 161 when the component elements 150-1, 150-2 of the Alvarez element 150 are in this reference position. The Alvarez element 150 leads to a defocus if the two component elements 150-1, 150-2 are displaced oppositely to one another from the reference position. The focal plane is displaced to in front of or behind the plane of the image sensor 161, depending on the direction in which the component elements 150-1, 150-2 are displaced oppositely to one another.

A pure defocusing effect may be obtained if the free-form surface of the component elements 150-1, 150-2 can be described by the following 3rd order polynomial:

$$z ( x , y ) = K \cdot ( {x}^{2} \cdot y + \frac{{y}^{3}}{3} )$$

In this case, the assumption is made that the lateral displacement of the component elements 150-1, 150-2 occurs along the y-axis, which is defined thereby. If the displacement should occur along the x-axis, the roles of x and y should be interchanged accordingly in the equation above. As it were, the parameter K effectively scales the profile depth and thus sets the obtainable change in refractive power per unit lateral displacement path s. For beams incident parallel to the axis, the lateral displacement of the optical components by a path s=|±y| brings about a change in the wavefront according to the equation:

$$Δ W ( x , y ) = K \cdot ( 2 \cdot s \cdot ( {x}^{2} + {y}^{2} ) + 2 \cdot \frac{{s}^{3}}{3} )$$

This corresponds to a change in the focal position by changing the parabolic wavefront component plus what is known as a piston term (Zernike polynomial with j=1, n=0 and m=0), where the latter corresponds to a constant phase and precisely does not have an effect on the imaging properties if the optical element according to the invention is situated in the infinite beam path. Further details regarding Alvarez elements may be gathered from e.g. DE 10 2011 055 777 A1, to which reference is made in this respect. Alternatively, use may also be made of achromatized Alvarez elements, as described in DE 10 2021 121 561 A1 or DE 10 2021 121 562 A1.

The present invention has been described in detail on the basis of exemplary embodiments for explanatory purposes. However, from the description, it is evident to a person skilled in the art that modifications of the exemplary embodiment are possible without deviating from the invention. Therefore, the invention is not intended to be limited by the exemplary embodiments but rather only by the appended claims.

### LIST OF REFERENCE SIGNS

2,2′ Surgical microscope
3 Operating field
4 Object plane
4 Plane conjugate to the sensor plane
5 Objective
7 Divergent component beam
9 Beam
9A,B Parallel component beam
10 Large beam splitter
11 Magnification changer
13A,B Interface arrangement
15A,B Beam splitter prism
19 Camera optics unit
21 Camera
23 Image sensor
24 Displacement
26 Piezo element
27 Binocular tube
29A,B Tube objective
31A,B Intermediate image plane
33A,B Prism
35A,B Eyepiece lens
37 Display
39 Optics unit
41A,B Light guide
43A,B Illumination optics unit
47 Controller
48 Image evaluation unit
49A,B Focusing lens
50 Monitor
51 Information device
61A,B Image sensor
63A,B Display
65A,B Eyepiece lens
67A,B Cable
149A,B Focusing lens
150 Alvarez element
150-1 Component element
150-2 Component element
161 Image sensor
301 Anterior eye chamber
303 Lens fragment
303′ Selected lens fragment
304 Inner edge of the iris
305 Tear edge of the lens capsule
306 Outer edge of the iris
307 Phaco needle
309 Distal end
311 Indicator
313 Grayscale
OA Optical axis
S1 Recording a stack of digital images
S2 Recognizing the lens fragments
S3 Ascertaining the position
S4 Ascertaining the image sharpness
S5 Ascertaining the position
S6 Selecting a lens fragment
S7 Calculating a distance
S8 Generating a superposition image
S9 Checking whether further lens fragments are present
S10 Terminating the method

1. A method for ascertaining the position of a phase object in an imaged observation region, at least along an optical axis of an imaging beam path for imaging the observation region, comprising the steps of:
recording digital images of the observation region by at least one image sensor, wherein the images each represent a plane in the observation region that is conjugate to the image plane of the at least one image sensor;
varying the position of the conjugate plane in the observation region along the optical axis, and recording a stack of digital images of the observation region with different positions of the conjugate plane in the observation region;
ascertaining the position of the phase object in the observation region along the optical axis from the stack of digital images by a digital image evaluation.

2. The method as claimed in claim 1, wherein the ascertainment of the position of the phase object from the stack of digital images along the optical axis comprises:
ascertaining the contrasts of the phase object in the images from the stack of digital images;
determining the position of the conjugate plane in the observation region along the optical axis for that digital image from the stack of digital images in which the phase object has the lowest contrast, and assigning the position of this conjugate plane in the observation region to the phase object as the position of the latter along the optical axis.

3. The method as claimed in claim 1, wherein the ascertainment of the position of the phase object along the optical axis is preceded by digital image evaluation being used to recognize the phase objects present in the imaged observation region on the basis of images from the stack of digital images.

4. The method as claimed in claim 3, wherein the positions of all recognized phase objects perpendicular to the optical axis are ascertained.

5. The method as claimed in claim 3, wherein the extent of the recognized phase objects perpendicular and/or parallel to the optical axis is also ascertained with the aid of digital image evaluation.

6. The method as claimed in claim 1, wherein the position of the conjugate plane in the observation region along the optical axis is varied:
by displacing the at least one digital image sensor along the optical axis or
by varying, in the imaging beam path leading to the at least one image sensor, the plane conjugate to the image sensor in the object space by an optical element.

7. A method for assisting the three-dimensional positioning of a distal end of a medical instrument to be identified in an image of an imaged observation region, relative to a phase object present in the imaged observation region, including the steps of:
ascertaining the position of the phase object at least along the optical axis of an imaging beam path for imaging the observation region, with the aid of the method as claimed in claim 1;
ascertaining a position of the distal end of the medical instrument, at least along the optical axis of the imaging beam path;
outputting an indicator that identifies the distance of the distal end of the medical instrument from the phase object, at least along the optical axis of the imaging beam path.

8. The method as claimed in claim 3, wherein the observation region is a segment of an eye, and lens fragments are present as phase objects, and a phaco needle is present as a medical instrument, additionally comprising the steps of:
ascertaining the position of the phase object at least along the optical axis of the imaging beam path for imaging the observation region;
ascertaining a position of the distal end of the medical instrument, at least along the optical axis of the imaging beam path;
outputting an indicator that identifies the distance of the distal end of the medical instrument from the phase object, at least along the optical axis of the imaging beam path;
a) selecting a first lens fragment and superimposing highlighting for the selected lens fragment, wherein the indicator is configured such that it renders identifiable the distance of the distal end of the phaco needle from the selected and highlighted first lens fragment, at least along the optical axis of the imaging beam path; and
b) should the lens fragment for which highlighting was superimposed previously no longer be present, selecting a subsequent lens fragment and superimposing highlighting for the subsequent lens fragment, wherein the indicator is configured such that it renders identifiable the distance of the distal end of the phaco needle from the selected and highlighted subsequent lens fragment, at least along the optical axis of the imaging beam path;
c) repeating step b) until no lens fragment is present anymore.

9. The method as claimed in claim 8, wherein the lens fragment with the greatest extent perpendicular and/or parallel to the optical axis is selected as the first lens fragment, the lens fragment with the second largest extent perpendicular and/or parallel to the optical axis is selected as the subsequent lens fragment and, when repeating step b), the lens fragment with the next smaller extent perpendicular and/or parallel to the optical axis is in each case selected as the subsequent lens fragment.

10. The method as claimed in claim 8, wherein highlighting for a lens fragment is only superimposed should the extent of the lens fragment perpendicular and/or parallel to the optical axis reach or exceed a minimum extent.

11. An optical observation apparatus, comprising:
at least one imaging beam path for imaging an observation region that contains at least one phase object;
at least one digital image sensor for recording digital images of the observation region, which each image a plane in the observation region that is conjugate to the image plane of the at least one image sensor;
a variation unit that is designed to vary the position of the conjugate plane in the observation region along the optical axis and to prompt the at least one digital image sensor to record a stack of digital images of the observation region with different positions of the conjugate plane in the observation region; and
an image evaluation unit that is designed to ascertain the position of the at least one phase object along the optical axis from the stack of digital images.

12. The optical observation apparatus as claimed in claim 11, wherein the image evaluation unit is designed
to ascertain the contrasts of the at least one phase object in the images from the stack of digital images;
to ascertain the position of the conjugate plane in the observation region along the optical axis for that digital image from the stack of digital images in which the phase object has the lowest contrast, and to assign the position of this conjugate plane in the observation region to the at least one phase object as the position of the latter along the optical axis.

13. The optical observation apparatus as claimed in claim 11, wherein the digital image evaluation unit is designed to recognize the phase objects present in the imaged observation region on the basis of images from the stack of digital images before the ascertainment of the position of the at least one phase object along the optical axis.

14. The optical observation apparatus as claimed in claim 11, wherein the digital image evaluation unit is designed to ascertain the positions of the at least one phase object perpendicular to the optical axis.

15. The optical observation apparatus as claimed in claim 11, wherein the digital image evaluation unit is also designed to ascertain the extent of the at least one phase object perpendicular and/or parallel to the optical axis.

16. The optical observation apparatus as claimed in claim 11, wherein the variation unit comprises one of the following devices:
a displacement device for displacing the at least one digital image sensor along the optical axis;
at least one optical element for introducing a defocus into the imaging beam path leading to the at least one image sensor.

17. The optical observation apparatus as claimed in claim 11, furthermore comprising:
an ascertainment unit for ascertaining the position of the distal end of a medical instrument, at least along the optical axis of the imaging beam path;
an information device for generating an indicator that identifies the distance of the distal end of the medical instrument from the phase object, at least along the optical axis of the imaging beam path; and
a superposition device for superimposing the indicator onto an image recorded with the aid of the at least one digital image sensor.

18. The optical observation apparatus as claimed in claim 13, wherein lens fragments are present as phase objects, and a phaco needle is present as a medical instrument, and the optical observation apparatus additionally comprises a controller that is connected to the digital image evaluation unit, the information device and the superposition device for the exchange of signals and that is configured:
an ascertainment unit for ascertaining a position of the distal end of a medical instrument, at least along the optical axis of the imaging beam path;
an information device for generating an indicator that identifies the distance of the distal end of the medical instrument-from the phase object, at least along the optical axis of the imaging beam path;
a superposition device for superimposing the indicator onto an image recorded with the aid of the at least one digital image sensor;
to select a first lens fragment from the lens fragments recognized by the digital image evaluation unit, to prompt the superposition device to highlight the selected first lens fragment and to prompt the information device to configure the indicator such that it renders identifiable the distance of the distal end of the phaco needle from the selected and highlighted first lens fragment, at least along the optical axis of the imaging beam path;
should the previously selected lens fragment no longer be present, to select a subsequent lens element from the lens fragments recognized by the digital image evaluation unit, to prompt the superposition device to highlight the selected subsequent lens fragment, to prompt the information device to configure the indicator such that it renders identifiable the distance of the distal end of the phaco needle from the selected and highlighted subsequent lens fragment, at least along the optical axis of the imaging beam path, and to repeat this procedure until no lens fragment is present anymore.

19. The optical observation apparatus as claimed in claim 18, wherein the controller is configured to select as the first lens fragment the lens fragment that has the greatest extent perpendicular and/or parallel to the optical axis and to select as the subsequent lens fragment the respective lens fragment that has the next smaller extent perpendicular and/or parallel to the optical axis.

20. The optical observation apparatus as claimed in claim 18, wherein the controller is designed to prompt the superposition device to highlight a lens fragment only if its extent perpendicular and/or parallel to the optical axis reaches or exceeds a minimum extent.

21. A computer-implemented method for determining the position of a phase object in an observation region, said computer-implemented method, when executed on a computer, prompting said computer to ascertain the position of the phase object along the optical axis from a stack of digital images of the observation region obtained using at least one digital image sensor, wherein the images of the stack each contain image representations of the phase object and have been recorded at different positions of a plane in the observation region that is conjugate to the image plane of the at least one image sensor.

22. The computer-implemented method for determining the position of a phase object in an observation region as claimed in claim 21, said computer-implemented method, when executed on a computer, prompting said computer
to ascertain the contrasts of the phase object in the images from the stack of digital images,
to determine the position of the conjugate plane in the observation region along the optical axis for that digital image from the stack of digital images in which the phase object has the lowest contrast and
to assign the position of this conjugate plane to the phase object as the position of the latter along the optical axis.

23. (canceled)

24. A computer-readable storage medium with data stored thereon, said data containing instructions that, when executed on a computer, prompt said computer to carry out the computer-implemented method as claimed in claim 21.

25. A data processing unit having a memory, a processor and, stored in the memory, a computer program having instructions that can be executed by the processor and, when executed by the latter, prompt said processor to carry out the computer-implemented method as claimed in claim 21.
